(19) United States
(12) Patent Application Publication
(10) Pub. No.: US 2024/0410987 A1
(43) Pub. Date: Dec. 12, 2024

(54) SWITCHED PIXEL ARRAY LiDAR SENSOR AND PHOTONIC INTEGRATED CIRCUIT

(71) Applicant: HRL Laboratories, LLC, Malibu, CA (US)

(72) Inventor: Keyvan SAYYAH, Santa Monica, CA (US)

(73) Assignee: HRL Laboratories, LLC, Malibu, CA (US)

(21) Appl. No.: 18/694,969

(22) PCT Filed: Sep. 25, 2022
(86) PCT No.: PCT/US2022/044646

§ 371 Date: Mar. 23, 2024

Related U.S. Application Data
(60) Provisional application No. 63/248,509, filed on Sep. 26, 2021.

(51) Int. Cl. G01S 7/481; G01S 17/42; G01S 17/894

(52) U.S. Cl. CPC G01S 7/4817; G01S 7/4811; G01S 7/4814; G01S 7/4816; G01S 17/42; G01S 17/894

(57) ABSTRACT

A switched pixel array LiDAR includes a transmit optical switching network and a receive optical switching network. The transmit optical switching network is connected to a transmit antenna in each pixel of the switched pixel array, and a receive optical switching network is coupled to receive antennas in each pixel. The transmit antenna length is at least 100 times greater than the transmit antenna width. The transmit optical switching network steers a transmit beam from a laser system to the transmit antenna in a selected pixel, and emits the transmit beam through a cylindrical lens towards a target. The transmit beam is reflected off the target as a receive beam passing through the cylindrical lens towards the receive antennas in the selected pixel. The receive optical switching network transmits the receive beam to an optical receiver system which generates a receive signal configured for extraction of sensor data associated with the target.

### CROSS-REFERENCE TO RELATED APPLICATIONS

The present application claims priority to U.S. Provisional Application No. 63/248,509 entitled CHIP-SCALE SWITCHED PIXEL ARRAY LIDAR WITH INTERLEAVED TRANSMIT/RECEIVER APERTURE filed on Sep. 26, 2021, the entirety of which is hereby incorporated by reference.

### TECHNICAL FIELD

This specification relates to Light Detection and Ranging (LiDAR) sensors.

### BACKGROUND

LiDAR is a method of measuring distance to an object by scanning laser light over the object and measuring properties (e.g., time of flight) of the reflected light. LiDAR is used in a variety of applications, including autonomous navigation, aerial 3D mapping, robotics, and many others. Many LiDAR systems include a scanning mechanism that scans the laser in order to provide spatial resolution over some cross-sectional area. The scanner can, for example, be a mechanical (such as scanning polygon mirror) or electro-mechanical scanner (such as microelectromechanical mirror (MEMS) that physically moves or rotates the transmit laser beam. Such a configuration can, however, be quite bulky and costly. A more compact LiDAR sensor, preferably with no moving parts, that is capable of scanning over a wide cross-sectional area is desirable for many applications.

### DESCRIPTION OF DRAWINGS

FIG. 1 is a diagram illustrating a LiDAR sensor including a switched pixel array that emits and receives beams through a free-space cylindrical lens, each pixel having a transmit antenna and multiple receive antennas where the antenna length is at least 100 times greater than the antenna width for the transmit antenna and the multiple receive antennas.

FIG. 2 a diagram illustrating a LiDAR sensor controller, laser driver, and a switch matrix controller for beam formation and steering, and a 3D image processor for extracting sensor data from a receive signal associated with a target according to an embodiment for the LiDAR sensor of FIG. 1.

FIG. 3 is a diagram illustrating a switched pixel array with the transmit antennas being spatially separated (non-interleaving) from the at least two receive antennas in each pixel according to alternate embodiment of the switch pixel array in the LiDAR sensor of FIG. 1.

FIGS. 4A and 4B are cross-section diagrams of the switch pixel array and the cylindrical lens of the LiDAR sensor in FIG. 1, with hybrid geometry depicting azimuthal steering angles for the transmit beam and the receive beam focused on a specific transmit/receive antenna pixel corresponding to its beam direction.

FIG. 5 is a schematic diagram illustrating architecture of the photonic integrated circuit of FIG. 2 having a tunable narrow linewidth laser according to one embodiment.

FIG. 6 is a schematic diagram illustrating architecture of a photonic integrated circuit having tunable narrow linewidth lasers, according to alternate embodiment of the photonic integrated circuit in FIG. 5.

FIG. 7 is a schematic diagram illustrating architecture of a photonic integrated circuit that replaces a narrow linewidth tunable laser system with a narrow linewidth optical frequency comb laser system, according to an alternate embodiment of the photonic integrated circuit in FIG. 5.

FIG. 8 is a schematic diagram illustrating architecture of a photonic integrated circuit that replaces the narrow linewidth tunable laser system with a narrow linewidth optical frequency comb laser system having multiple tunable microresonators configured to extract comb lines in parallel resulting in MxK 2D LiDAR positions, according to an alternate embodiment of the photonic integrated circuit in FIG. 5.

FIG. 9 is a graph illustrating simulated signal-to-noise ratio for two examples of switched pixel array chip-scale Lidar sensors according to alternate embodiments.

In the figures, like reference symbols in the various figures indicate like elements.

### DETAILED DESCRIPTION

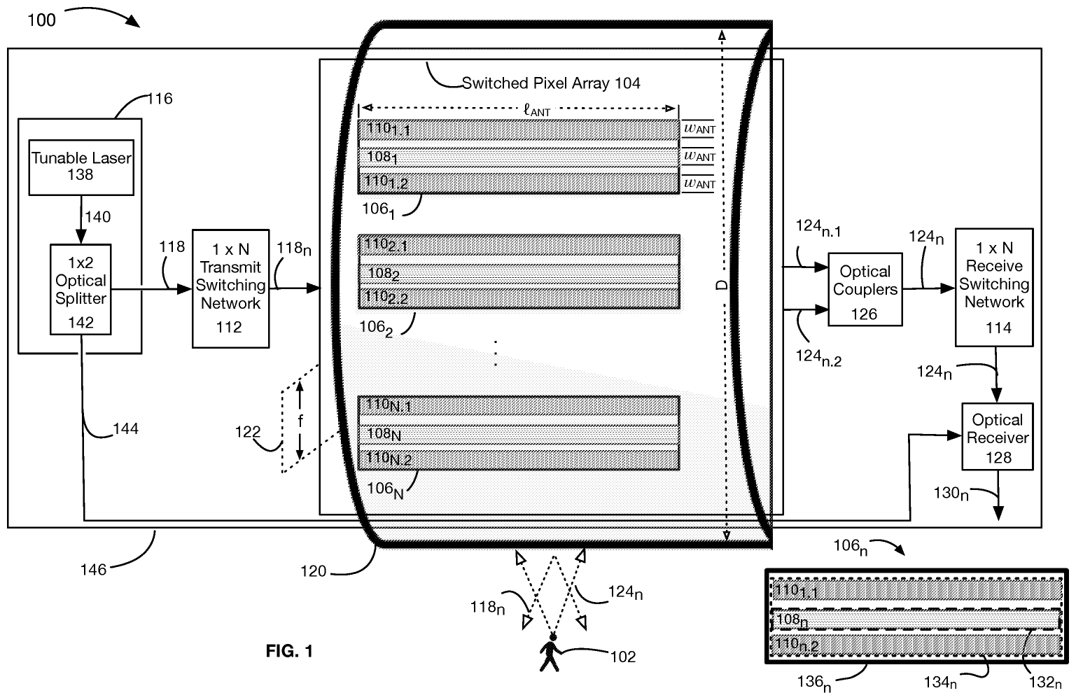

FIGS. 1-9 illustrate embodiments of a LiDAR sensor for applications such as (a) autonomous vehicles and advanced driver assistance systems with demands for smaller, lower cost LiDAR chips; (b) aerospace devices having requirements for longer range (km-range) target detections; and (c) commercial robotic applications such as logistics and warehousing, medical and surgical, agricultural, inspection, and security. The LiDAR sensor may be a frequency modulated continuous wave (FMCW) LiDAR sensor, according to one embodiment. Alternatively, the LiDAR sensor may be a pulsed time-of-flight (ToF) LiDAR sensor.

The disclosed embodiments include an indexed numbering system with subscripts having lower case letters n, m, or k to identify 1) a selected antenna pixel n from N antenna pixels, 2) a selected laser system or laser beam m from M laser systems or laser beams, 3) a selected optical wavelength or tunable microresonator k from K optical wavelengths or tunable microresonators, and 4) transmit and receive beams respectively associated with the selected pixel n, the selected laser system m, and the selected wavelength k. The letter N is the number of transmit antennas in a switched pixel array of the LiDAR sensor, each selected antenna pixel n having a single transmit antenna Txₙ and a plurality of P receive antennas Rx_{n.1} to Rx_{n.P}.

FIG. 1 illustrates an embodiment of a LiDAR sensor 100 that provides sensor data from a target 102. LiDAR sensor 100 includes a switched pixel array 104 having N antenna pixels 106₁ to 106_{N}. Each pixel 106ₙ in the plurality of pixels 106₁ to 106_{N} includes a single transmit antenna 108ₙ, and a plurality of receive antennas 110_{n.1} to 110_{n.P}. The subscript n is the n^{th} pixel in the N pixels 106₁ to 106_{N}. The subscript P is the number of receive antennas in the plurality of receive antennas 110_{n.1} to 110_{n.P} in each pixel 106ₙ. The transmit antenna 108ₙ may be interleaved between at least two receive antennas 110_{n.1} and 110_{n.2} for each pixel 106ₙ as illustrated in the switched pixel array 104 of FIG. 1. A transmit optical switching network 112 is coupled to the transmit antenna 108ₙ in each pixel 106ₙ, and a receive optical switching network 114 is coupled to the at least two receive antennas 110_{n.1} and 110_{n.2} in each pixel 106ₙ. The transmit antenna 108ₙ and the at least two receive antennas 110_{n.1} and 110_{n.2} for each pixel 106ₙ have an antenna width W_{ANT} and an antenna length [symbol] _{ANT}. The antenna length [symbol] _{ANT} is at least 100 times greater than the antenna width WANT.

A laser system 116 provides a transmit beam 118, and the transmit optical switching network 112 is configured to steer the transmit beam 118 to the transmit antenna 108ₙ in a selected pixel 106ₙ from the plurality of pixels 106₁ to 106_{N}. The transmit antenna 108ₙ from the selected pixel 106ₙ emits the transmit beam 118ₙ through a free-space cylindrical lens 120 towards the target 102. The cylindrical lens 120 has a diameter D and is positioned one focal length (shown as 122) above the switched pixel array 104. Also, the switched pixel array 104 is be positioned along the focal plane of the cylindrical lens 120. The transmit beam 118ₙ is reflected off the target 102 as a receive beam 124ₙ passing through the cylindrical lens 120 towards the at least two receive antennas 110_{n.1} to 110_{n.2} in the selected pixel 106ₙ. The two receive antennas 110_{n.1} to 110_{n.2} collect the receive beam 124ₙ and respectively provide a receive beam 124_{n.1} and a receive beam 124_{n.2}. An integrated 2×1 optical coupler 126 may be used to coherently combine the receive beam 124_{n.1} and the receive beam 124_{n.2} into one output waveguide as the receive beam 124ₙ that is routed to the receive optical switching network 114. The 2×1 optical coupler 126 may include an integrated Mach-Zehnder interferometer (MZI) in which a fixed phase shift of 180° is implemented in one waveguide arm of an otherwise symmetric interferometer resulting in the coherent combination of the two input lightwaves into an output waveguide.

The receive optical switching network 114 is configured to steer the receive beam 124ₙ from the at the least two receive antennas 110_{n.1} and 110_{n.2} in the selected pixel 106ₙ to an optical receiver system 128. The optical receiver system 128 is configured, responsive to the receive beam 124ₙ, to generate a receive signal 130ₙ that is configured for extraction of the sensor data associated with the target 102.

In one embodiment, the transmit antenna 108ₙ has a transmit receive aperture 132ₙ, and at least two receive antennas 110_{1.1} and 110_{n.2} have a receive aperture 134ₙ. The transmit aperture 132ₙ is interleaved in the receive aperture 134ₙ to provide an interleaved transmit/receive aperture 136ₙ for each pixel 106ₙ. Accordingly, switched pixel array 104 includes N interleaved transmit/receive apertures 136₁ to 136_{N} respectively associated with the N pixels 106₁ to 106_{N}. The transmit beam 118ₙ is emitted from the transmit aperture 132ₙ of the interleaved transmit/receive aperture 136ₙ for the selected pixel 106ₙ, and the receive beam 124ₙ is detected by the receive aperture 134ₙ of the interleaved transmit/receive aperture 136ₙ for the selected pixel 106ₙ. The N interleaved transmit/receive apertures 136₁ to 136_{N} provide N azimuthal beam positions and angles for the transmit beam 118ₙ and the receive beam 124ₙ. The interleaved transmit/receive aperture architecture reduces chip footprint for the LiDAR sensor 100, which can lower chip cost when compared to a LiDAR sensor having separate transmit and receive apertures. Furthermore, the interleaved transmit/receive aperture architecture can eliminate an optical parallax effect that may occur in the case of separate transmit and receive apertures which would result in no LiDAR signal detection at short ranges (for example, a transmit and receive aperture separation of 14 mm results in no LiDAR signal detection at ranges shorter than 8 m). Also, at least two receive antennas 110_{1.1} and 110_{n.2} are coherently combined in the receive aperture 134ₙ to help improve the signal-to-noise ratio.

The laser system 116 includes a tunable laser 138 that provides a modulated laser beam 140, and a 1×2 optical splitter 142 that splits the modulated laser beam 140 into the transmit beam 118 and a local oscillator beam 144. The splitting ratio is selected to have most of the integrated laser optical power from the modulated laser beam 140, such as about 90-95%, routed to the transmit optical switching network 112. The remaining power, such as about 5-10%, is routed as the local oscillator (LO) beam 144 to the optical receiver 128. For example, the tunable laser 138 may have a narrow linewidth of less than 10 KHZ with a tunable wavelength greater than 100 nm. Also, the tunable laser 138 may span more than 100 nm of the optical spectrum in the 1550 nm communication band based on, for example, tunable microresonators or sampled grating distributed Bragg reflectors. The 1×2 optical splitter 142 may be based on a number of integrated photonic coupler/splitter technologies such as directional coupler (DC) or a multi-mode interference (MMI) coupler.

The transmit optical switching network 112 and the receive optical switching network 114 in conjunction with a selected position of the plurality of pixels 106₁ to 106_{N} relative to an optical axis of the cylindrical lens 120 may be configured and controlled for azimuthal beam steering. Also, the wavelength of the tunable laser 138 is scanned in conjunction with the plurality of pixels 106₁ to 106_{N} for elevational beam steering. For example, the transmit beam 118 is switched (steered) to a selected transmit antenna 106ₙ in the switched pixel array 104 via the transmit optical switching network 112, and is subsequently outcoupled from the switched pixel array 104 via the selected transmit antenna 108ₙ at an azimuthal steering angle to the target 102.

The transmit antennas and the receive antennas in the switched pixel array 104 may be multi-millimeter long dispersive optical antennas that are combined with the free-space cylindrical lens 120 that is positioned one focal length above switched pixel array 104. The combination of multi-millimeter long transmit and receive optical antennas in the switch pixel array 104 with the cylindrical lens 120 helps increase the effective receive aperture size of switched pixel array 104. The LiDAR sensor 108 may have a scalable effective receive aperture, and hence LiDAR range, by increasing the size of the switched pixel array 104 with dispersed antenna elements along its width and increasing the diameter of the cylindrical lens 104.

The LiDAR sensor 100 has detection capability at a range greater than 200 m. The LiDAR sensor 100 may have km-range target detection with the use of the cylindrical lens 120 having larger diameter that increases the effective receive aperture for receive apertures 1341 to 134_{N} while steering in the elevational direction with wavelength scanning of the tunable laser 138. In this example embodiment with the cylindrical lens 104 having larger diameter, the azimuthal steering field-of-view (FOV) may be reduced if the number of pixels 106₁ to 106_{N} in the switched pixel array 104 remains the same (not increased for the larger diameter lens), assuming the inter-pixel spacing is unchanged. Alternatively, the azimuthal steering FOV may remain the same if the number of pixels 106₁ to 106_{N} is increased for a larger diameter embodiment of the cylindrical lens 120.

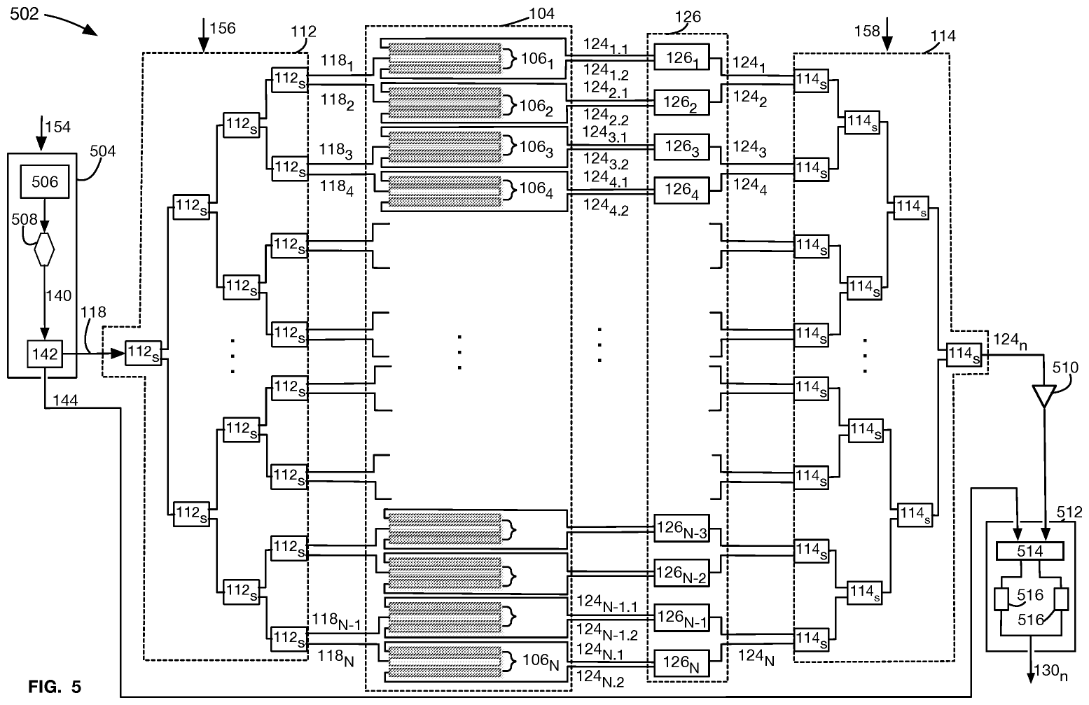

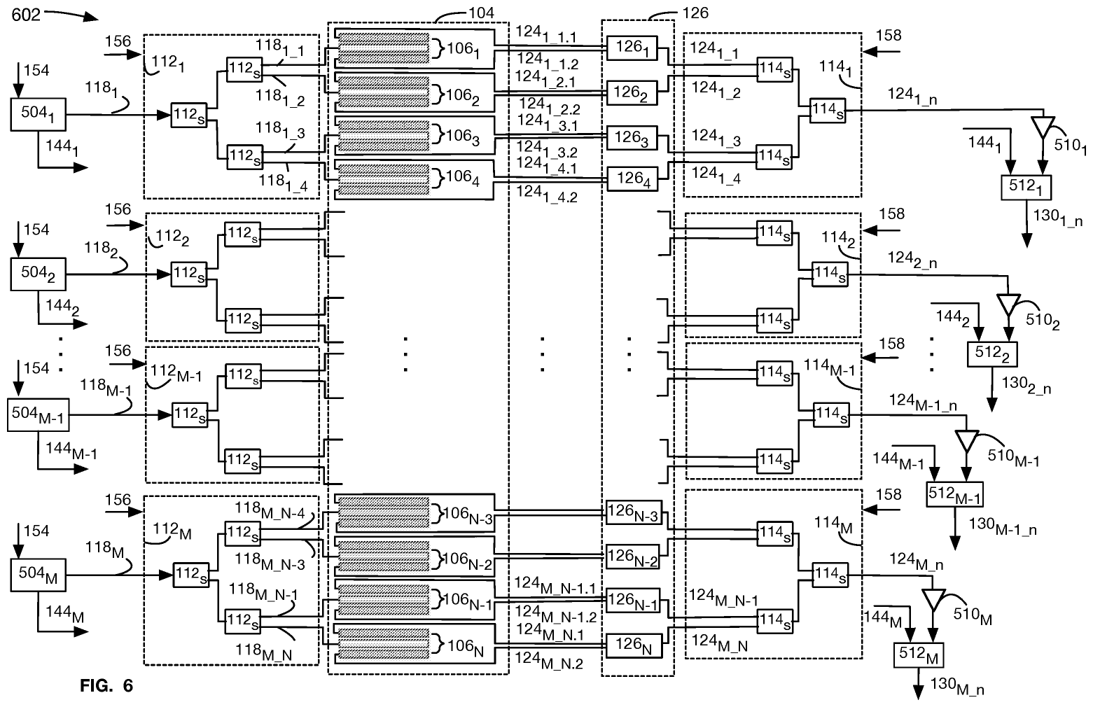

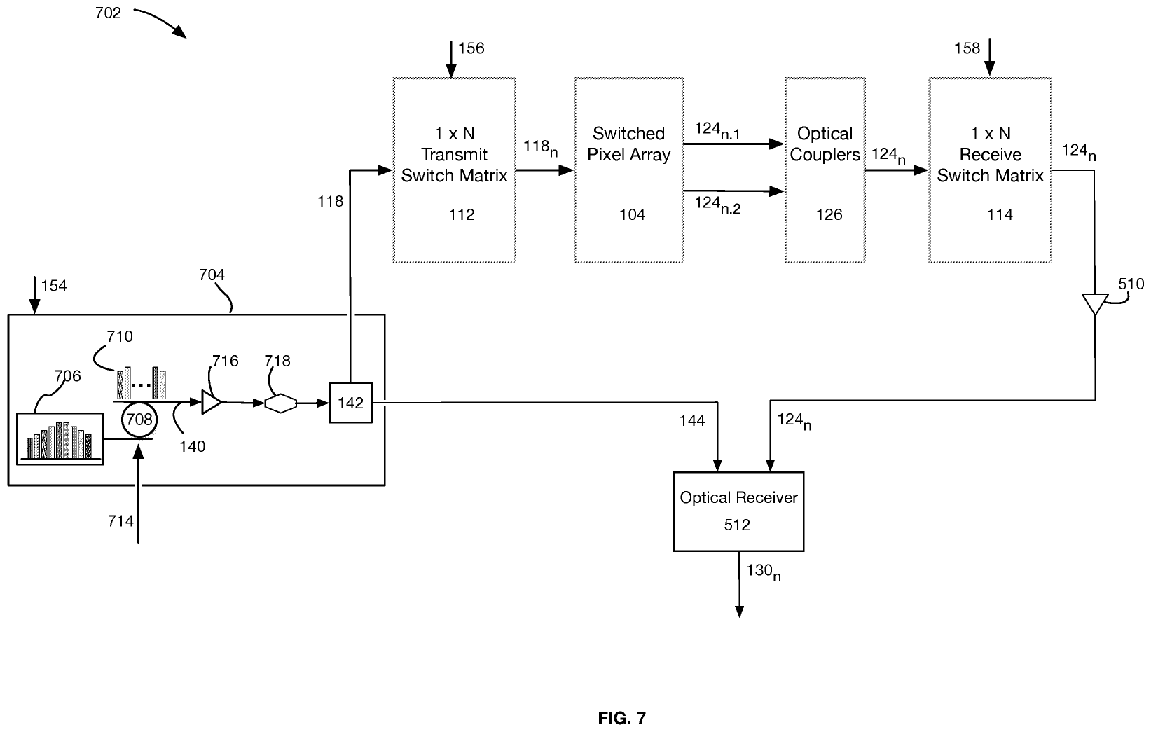

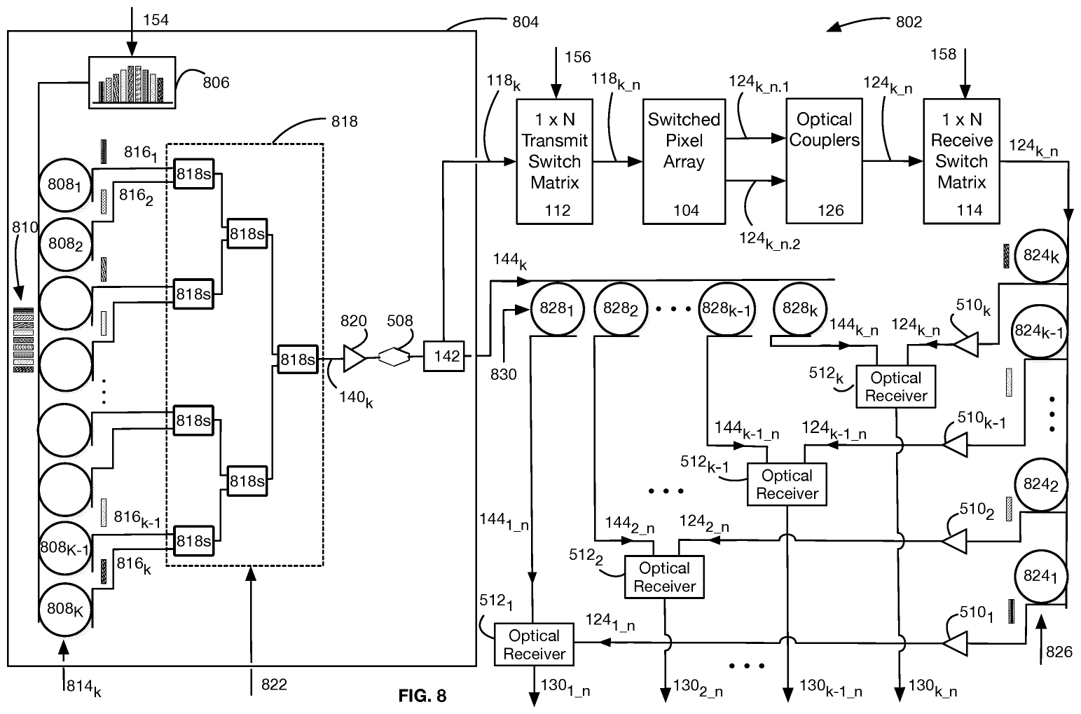

The LiDAR sensor 100 architecture may provide 1D switched pixel array 104 in conjunction with wavelength scanning of the tunable laser 138 to implement 2D scanning for beam formation and steering. The wavelength scanning for elevational beam steering may be achieved via several different embodiments of the tunable laser 138. For example, the tunable laser 138 may be a narrow linewidth and widely tunable (>100 nm) integrated laser source as illustrated in FIGS. 5 and 6. Alternatively, the tunable laser 138 may be a narrow linewidth optical frequency comb (OFC) laser source in conjunction with one or more integrated tunable microresonators as illustrated in FIGS. 7 and 8.

The LiDAR sensor 100 may include a photonic integrated circuit 146 such as a chip-scale LiDAR or photonic chip having the switched pixel array 104, the transmit optical switching network 108, the receive optical switching network 110, the laser system 112, and the optical receiver 124. The cylindrical lens 120 is positioned one focal length above the photonic integrated circuit 146.

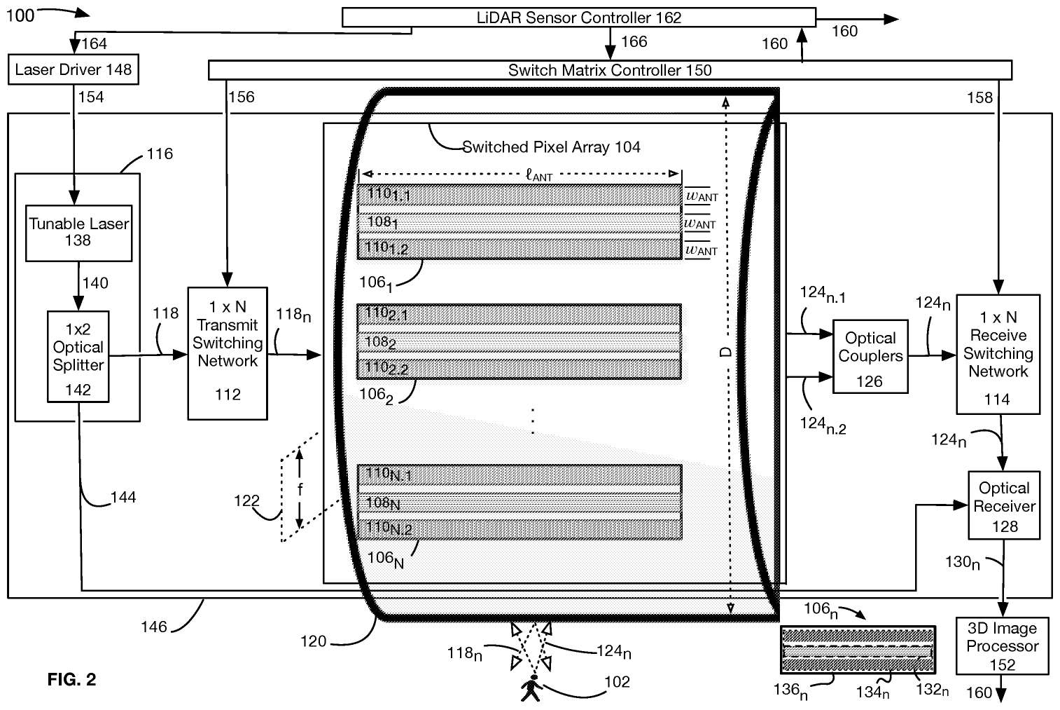

FIG. 2 illustrates an embodiment of the LIDAR sensor 100 of FIG. 1 which further includes a laser driver 148, a switch matrix controller 150, and a 3D image processor 152. The laser driver 148 is configured to control output power and wavelength of the laser system 116. The switch matrix controller 150 is configured to control selection of the transmit optical switching network 112 and the receive optical switching network 114. For example, the laser driver 148 provides a driver control signal 154 to control the wavelength of the tunable laser 138 for elevational beam steering. The switch matrix controller 150 provides a transmit switch control signal 156 to the transmit optical switching network 112 and a receive switch control signal 158 to the receive optical switching network 114 for azimuthal beam steering. The transmit switch control signal 154 switches the transmit path for the transmit beam 118 so that it is routed to the transmit antenna 108ₙ and emitted as the transmit beam 118ₙ from the transmit aperture 132ₙ of the interleaved transmit/receive aperture 136ₙ during a pixel detection time period. The receive switch control signal 158 controls the receive switch network 114 to (a) select the receive path for the receive beam 124ₙ collected from the receive antennas 110_{n.1} and 110_{n.2} through the receive aperture 134ₙ of the interleaved transmit/receive aperture 136ₙ and (b) route the receive beam 124ₙ to the optical receiver system 128 during the pixel detection time period. The optical receiver system 128 is configured, responsive to the receive beam 124ₙ, to generate the receive signal 130ₙ. The 3D image processor 152 is configured to detect and process sensor data 160 in the receive signal 130ₙ. For example, the sensor data 160 may include range and reflectance data processed from the receive signal 130ₙ or a sequence of receive signals 130₁-130_{N} during detection time periods or cycles.

The LIDAR sensor 100 illustrated in the embodiment of FIG. 2 may include a LiDAR sensor controller 162 for providing a laser operation command 164 to the laser driver 148 and a switch operation command 166 to the switch matrix controller 150. The LiDAR sensor controller 162 receives the sensor data 160 from the 3D image processor 152 and provides the sensor data 160 to a host device such as an object detector in an autonomous vehicle. The LiDAR sensor controller 162 may be configured to perform further image processing of the sensor data 160 for the host device. In the embodiment of the LiDAR sensor 100 illustrated in FIG. 2, the photonic integrated circuit 146 is connected to the laser driver 148, the switch matrix controller 150, and the 3D image processor 152. The LiDAR sensor 100 may further include a system-on-chip that integrates the LiDAR system controller 156, the laser driver 148, the switch matrix controller 150, the 3D image processor 152, and the photonic integrated circuit 146.

The driver control signal 154, the transmit switch control signal 156, and the receive control signal 158 may be provided to control the laser system and switching networks for the embodiments of the photonic integrated circuit illustrated in FIGS. 5-8. Also, the 3D image processor 152 may be configured to detect and process sensor data 160 from the receive signal 130ₙ from the embodiments in FIGS. 5-8.

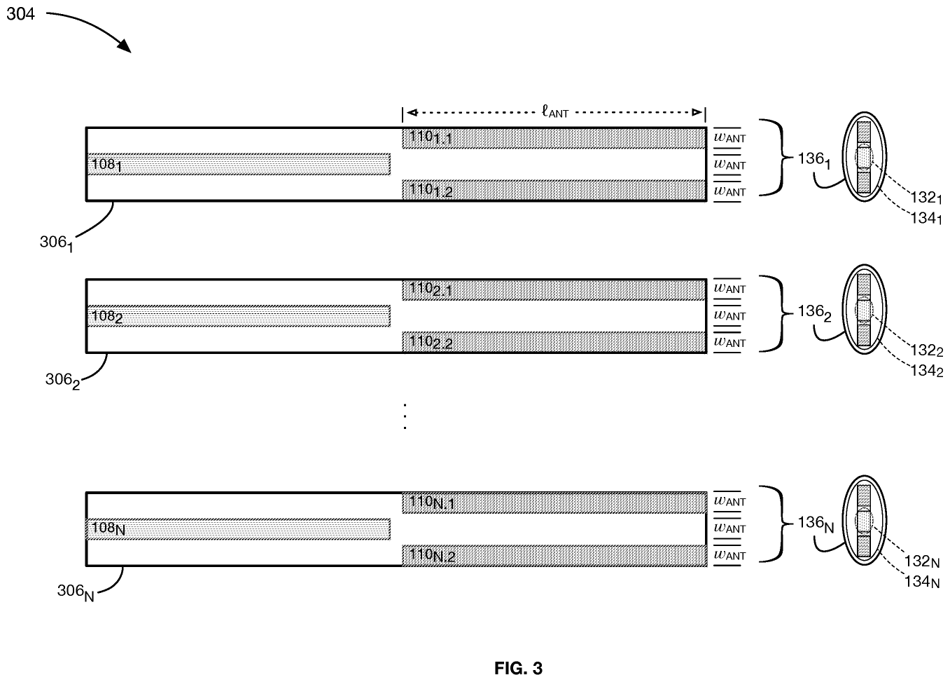

FIG. 3 illustrates a switched pixel array 304 according to an alternate embodiment of the switched pixel array 104 in FIGS. 1 and 2. The switched pixel array 304 includes a plurality of pixels 306₁ to 306_{N}. Each pixel 306_{N} includes the transmit antenna 108ₙ and at least two receive antennas 110_{n.1} and 110_{n.2} illustrated in the switched pixel array 104 of FIGS. 1 and 2. In the switched pixel array 304, the transmit antenna 108ₙ is spatially separated (non-interleaving) from the at least two receive antennas 110_{n.1} and 110_{n.2} in a direction of the antenna length [symbol] _{ANT}. The remaining aspects of the switched pixel array 304 are the same as the switched pixel array 104. For example, the switched pixel array 304 includes the interleaved transmit/receive apertures 136₁ to 136_{N} illustrated in the embodiment of the switched pixel array 104. Also, the switch pixel array 304 functions the same as the switch pixel array 104, with the switched pixel array 304 having a larger size for the chip footprint and the cylindrical lens 120 due to the separation of the transmit and receive antennas.

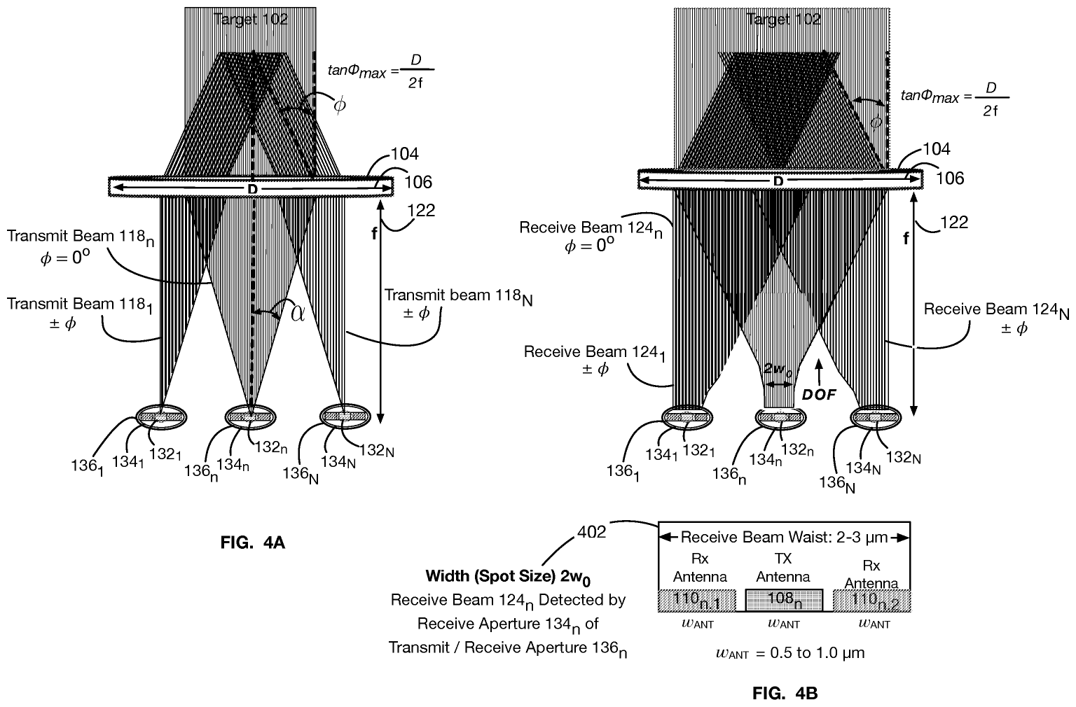

FIGS. 4A and 4B are cross-section diagrams of the switch pixel array 104 and the cylindrical lens 120 of FIG. 1, with hybrid geometry depicting azimuthal steering angles for the transmit beam 118 (FIG. 4A) and the receive beam 124 (FIG. 4B). The cross-section diagrams are the same for an embodiment of the LiDAR sensor having the switched pixel array 304 shown in FIG. 3. The transmit optical switching network 112 and the receive optical switching network 114 are controlled to sequentially, or randomly switch (scan) between the transmit/receive apertures 136₁, 136ₙ, and 136_{N} (associated with pixels 106₁, 106ₙ, and 106_{N} for steering the azimuthal beam positions of the transmit beam 118ₙ and the receive beam 124_{n.}

The transmit beam 118ₙ and the receive beam 124ₙ are steered at the maximum azimuthal steering angles given by:

$${ϕ}_{max} = {tan}^{- 1} ( \frac{D}{2 f} ) = \pm {tan}^{- 1} ( NA )$$

where D is the diameter, f is the focal length, and NA is the numerical aperture of the cylindrical lens 120 of FIG. 1. The steering at any azimuthal angle between Ø=0° and

$${ϕ}_{max} = \pm {tan}^{- 1} ( \frac{D}{2 f} )$$

is given by:

$$ϕ = \pm {tan}^{- 1} ( \frac{x}{2 f} )$$

where x is the distance between the transmit antenna 108ₙ and the optics axis of the cylindrical lens 120. For example, the cylindrical lens 120 may have a numerical aperture of NA=0.67 results in maximum azimuthal steering angle of ±38° or field-of-view of FOV=76°. In order to increase the azimuthal steering angle ϕₘₐₓ or FOV to ˜90°, the numerical aperture of the cylindrical lens 120 has to approach NA=1.

In FIG. 4A, the transmit beam 118 is emitted from the transmit antennas 108₁, 108ₙ, and 108_{N} (shown in FIG. 1) of the transmit/receive apertures 136₁, 136ₙ, and 136_{N} through the cylindrical lens 120 towards the target 102. The transmit/receive apertures 136₁ and 136_{N} are at the two ends of the switched pixel array 104 and the transmit/receive aperture 136ₙ is at the middle (center) of the switched pixel array 104.

Referring to FIG. 4B, the transmit beams 118₁, 118ₙ and 118_{N} are scattered or reflected off the target 102 as the receive beams 124₁, 124ₙ and 124_{N}, and are incident on the cylindrical lens 120 as collimated beams since the range-to-target is much larger than the diameter of the cylindrical lens 120 (such as multiple meters vs. a few centimeters). Hence, the receive beams 124₁, 124ₙ and 124_{N} are focused on the same transmit/receive apertures 136₁, 136ₙ, and 136_{N} (associated with the pixels 106₁, 106ₙ, and 106_{N}) that transmitted the corresponding transmit beams 118₁, 118ₙ and 118_{N} through the cylindrical lens 120 toward the target 102.

The width (spot size) of the focused receive beam 124ₙ detected by the two receive antennas 110_{n.1} to 110_{n.2} in the receive aperture 134ₙ of the interleaved transmit/receive aperture 136ₙ is 2 w₀. The width (spot size) 2 w₀ is the beam waist of the receive beam 128ₙ at the focal plane of the cylindrical lens 120, and is given by:

$$2 {w}_{0} = \frac{4 λ}{π} \frac{f}{D}$$

where, λ is the operating wavelength of the laser system 116.

The inset 402 shows the geometry of the antenna width WANT with respect to the width of the receive beam 124ₙ detected by the two receive antennas 110_{n.1} to 110_{n.2} in the receive aperture 134ₙ of the interleaved transmit/receive aperture 136ₙ. The two receive antennas 110_{n.1} to 110_{n.2} may be on either side of the transmit antenna 108ₙ (in the interleaved transmit/receive aperture 136ₙ) with respect to the spot size (beam waist) for the receive beam 124_{n.}

For example, for a cylindrical lens 120 having NA=0.67, the beam waist of the receive beam 124ₙ at the focal plane of the cylindrical lens 120 and centered at the transmit antenna 108ₙ of pixel 106ₙ is about 1.3 μm. Optical lenses also have a depth of focus (DOF) given by:

$$DOF = \frac{8 λ}{π} {( \frac{f}{D} )}^{2}$$

For the cylindrical lens 120 in this example embodiment, the depth of focus is about 1.6 μm as per the above equation. Within this depth of focus, the beam waist varies with the depth (z) as:

$${w ( x )}^{2} = {w}_{0}^{2} [ 1 + {( \frac{λ z}{π {w}_{0}^{2}} )}^{2} ]$$

Hence, for this example embodiment, the beam waist within the depth of focus is about 1.3-3.0 μm. Consequently, the two receive antennas 110_{1.1} to 110_{n.2} and on either side of the transmit antenna 108ₙ in the interleaved transmit/receive aperture 136ₙ of pixel 106ₙ will intersect the beam waist assuming that the antenna width WANT for the transmit antenna 108ₙ and the receive antennas 110_{n.1} to 110_{n.2} are in the range of 0.5-1.0 μm. This range for the antenna width WANT is illustrated in J. He et al., “Review of photonic integrated optical phased arrays for space optical communication,” IEEE Access 2020. Therefore, about 60-70% of the receive beam 124ₙ in the azimuthal direction is collected by the dual receive antennas 110_{n.1} to 110_{n.2} on either side of the optical transmit antenna 108ₙ that emitted the transmit beam 118ₙ.

Referring to FIG. 4A, the full-angle divergence (beamwidth) of the transmit beam 118ₙ in the azimuthal direction (an) is dependent on the width WANT of the transmit antenna 108ₙ and the focal length f of the cylindrical lens 120, which can be derived to be:

$${α}_{h} ∼ \frac{{w}_{ANT}}{f}$$

Thus, for widths of the transmit antennas 108₁ to 108_{N} in the range of 0.5-1.0 μm, the width of the transmit beam 118ₙ in the azimuthal direction is about 0.05-0.1 mrad (0.003°-0.006°) for the cylindrical lens 120 having a focal length of 10 mm.

In the embodiment of the LiDAR sensor 100 of FIG. 1, beam steering in the elevational direction is achieved via scanning the wavelength of the laser system 118. For example, elevational beam steering technique is illustrated for optical phase array beam steering in C. Poulton et al., “Long range Lidar and free-space Datacom with high performance optical phased arrays,” IEEE J. Sel. Top. Quant. Electron., Vol. 25, No. 5, 2019.

The elevational steering angle (θ) per unit wavelength (λ) scan is given by:

$$\frac{d θ}{d λ} = \frac{1}{cos θ} ( \frac{{d}_{neff}}{d λ} - \frac{1}{{Λ}_{G}} )$$

where n_{eff} is the effective index of the dispersive waveguide grating based antenna element and κ_{G} is the average period of the grating. As an example, for a Si waveguide based grating antenna, dθ/dλ, is ˜0.16°/nm at close to surface normal outcoupling angle (θ˜0°) with a typical grating pitch of ˜650 nm. To achieve wider azimuthal steering angles for the same wavelength span, the transmit antennas 108₁ to 108_{N} can be designed for an off-normal outcoupling angle (θ>0). For example, for an antenna design with an off-normal outcoupling angle of ˜50°, azimuthal steering of 25° can be achieved with 100 nm wavelength scan.

The transmit beam full-angle beamwidth in the elevational direction (αᵥ) is determined by the length of the antenna, L_{ANT}, as the cylindrical lens 120 used in the switched pixel array 104 does not modify the transmit beam phase front in this elevational direction and the far-field beam collimation is achieved via the length of the antenna:

$${α}_{h} ∼ \frac{λ}{{L}_{ANT}}$$

For typical optical antenna lengths varying between 5-10 mm, the beamwidth in the elevational direction is 0.15-0.3 mrads (0.009°-0.017°).

FIG. 5 is a schematic diagram illustrating the architecture of a photonic integrated circuit 502 having a tunable narrow linewidth laser according to a frequency modulated continuous wave (FMCW) embodiment of the photonic integrated circuit 146 of FIG. 2. The photonic integrated circuit 502 includes a laser system 504 having a tunable narrow linewidth laser 506 coupled to an optical modulator 508 to provide the modulated laser beam 140. The tunable narrow linewidth laser 506 may have a narrow linewidth less than 10 kHz with a tunable wavelength greater than 100 nm, according to one embodiment. The laser system 504 includes the 1×2 optical splitter 142 to split the modulated laser beam 140 into the transmit beam 118 that is routed to the transmit switch matrix 112 and the local oscillator beam 144 that is routed to an optical receiver 512.

The transmit switch matrix 112 includes a plurality of transmit optical switch elements 112ₛ for steering the transmit beam 118ₙ to a transmit antenna 108ₙ (such as illustrated in the switched pixel array 104 of FIG. 1) of a selected pixel 106ₙ. Similarly, the receive switch matrix 114 includes a plurality of receive optical switch elements 114ₛ for routing the receive beam 124ₙ to the optical receiver 512. The switch matrix topology may be a tree-based matrix fabric according to one embodiment illustrated in FIG. 5. However, other switch matrix topologies, such as butterfly, Benes, crosspoint and Banyan may also be used, as illustrated in B. G. Lee et al., “Silicon photonic switch fabrics: Technology and architecture,” JLT 2018, doi: 10.1109/JLT.2018.2876828.

The optical switches in the switching network 112 and 114 may be implemented using a number of integrated photonic switch approaches including, for example, Mach Zehnder interferometer (MZI) (integrated with optical phase shifters) and microring resonator (MRR) based switch architectures, or a microelectromechanical (MEMS) switch. Other approaches may be used. Integrated photonic switch implementations with a low propagation loss (<0.1 dB) are preferred due to the built-up aggregate optical losses inherent in the cascaded multi-stage switch networks encountered by the transmit and received beam as it propagates from the laser source through the transmit antenna array, back through the receive switch network onward to the optical receiver 512.

For example, for a chip-scale switched pixel array Lidar architecture with 1024 transmit beam positions in the azimuthal direction, 10 stages or layers of switches are required, which collectively result in a 1 dB optical loss over the entire switch matrix in each of the transmit and receive directions, when using low-loss (<0.1 dB for a single stage) switches. MZI based integrated photonic switch implementations with a low-loss (<0.1 dB) thermo-optic phase shifter are suitable for this component of the disclosed chip-scale Lidar architecture. There is generally a trade-off between the optical loss and phase modulation speed of integrated photonic phase shifters used in MZI based switch implementations. For example, thermo-optic phase shifters that have a low optical loss (<0.1 dB) generally have phase modulation speeds of 10's of microseconds or lower. On the other hand, semiconductor PN junction based integrated photonic phase shifters, such as Si photonic based PN junction phase shifters, have much faster phase modulation speeds of <10 ns, but suffer from a higher optical loss of 2-3 dB, which may result in a total optical loss of 20-30 dB for the 10-stage switch matrix example developed above for each transmit and receive direction. This will severely impact the Lidar signal-to-noise ratio (SNR), but the Lidar sensor would benefit from much faster beam position switching, which, in turn, will result in a higher Lidar 3D points per second throughput not possible with slower phase modulators implemented in each switch. MEMS based switches have a low optical loss (<0.1 dB), with a switching speed of 10's of microseconds, similar to the thermal phase shifter-based switches described above. The range for optical loss and minimum phase modulate speed may be balanced and selected according to the intended application.

The receive switch matrix 114 is coupled to each of the 2×1 optical couplers 126₁ to 126_{N} for (a) combining receive beams 124_{n.1} to 124_{n.1} collected at the receive antennas 110_{n1.1} and 110_{n.1} (such as illustrated in the switched pixel array 104 of FIG. 1) from the selected pixel 106ₙ and (b) routing the receive beam 124ₙ to the optical receiver 512. An optional semiconductor optical amplifier (SOA) 510 may be integrated between the receive switch matrix 114 and the optical receiver 512 to further boost the power of the signal provided to the optical receiver 512 and in so doing, increase the FMCW Lidar range. The optical receiver 512 may comprise a 2×2 optical coupler 514, which may be configured to optically combine the local oscillator beam 144 and the receive beam 124ₙ (optionally amplified). In one embodiment, the optical receiver 512 carries out homodyne detection to extract information encoded as modulation of the phase, frequency (or both) of the receive beam 124ₙ. The optically combined beams are detected in a photodiode detector, such as a dual balanced photodetectors 516 in order to eliminate the laser intensity noise. In the FMCW lidar mode of operation, the signal detected by the photodiode detector, referred to as the beat signal, is proportional to the range to target. The 3D image processor 152 illustrated in the embodiment of FIG. 2 extracts distance and positional information from the receive signal 130ₙ provided by the optical receiver 512.

FIG. 6 is a schematic diagram illustrating the architecture of a photonic integrated circuit 602 having a plurality of lasers systems 504₁ to 504_{N} according to another embodiment of the photonic integrated circuit 502 of FIG. 5. The subscript M is the number of tunable narrow linewidth lasers in the M laser systems 504₁ to 504_{M}. Each of the laser system 504₁ to 504_{N} is the same as the laser system 504 having a tunable narrow linewidth laser 506 as illustrated in the embodiment of FIG. 5. The plurality of laser systems 502₁ to 502_{N} use integrated and tunable lasers to simultaneously generate a plurality of (M) transmit beams 118₁ to 118_{M} and associated local oscillator beams 144₁ to 144_{M}.

In operation, the M simultaneous transmit beams 118_{1_n} to 118_{M} n are routed via optical waveguides to a respective one of the M transmit optical switching matrices 112₁ to 112_{M}. Each of the M transmit optical switching matrices 112₁ to 112_{M} may comprise 1×2 optical switches 112ₛ to switch transmit beam 118_{m.n} to a transmit antenna 108ₙ of a selected pixel 106ₙ associated with a laser system 504ₘ. The subscript m is the m^{th} laser system in the M laser systems 504₁ to 504_{M}. The subscript n is the n^{th} pixel in the N pixels 106₁ to 106_{N}. Each pixel 106ₙ includes at least two receive antennas 110_{n.1} and 110_{n.2} (illustrated in the switch pixel array 104 of the embodiment in FIG. 1) that collect receive beams 124_{m_n.1} and 124_{m_n.2} that are coupled to a respective 2×1 optical coupler 126ₙ that routes a receive beam 124_{m_n} to an associated receive optical switching matrix 114ₘ. Each receive switch matrix 114ₘ is configured to selectively switch the receive beam 124_{m_n} from the pixel 106ₙ to an optical receiver 512ₘ, optionally via a semiconductor optical amplifier 510_{M}. Each of the optical receiver 512₁ to 512_{M} (one for each of the M laser systems 504₁ to 504_{M}) is the same as optical receiver 512 illustrated in the embodiment of FIG. 5. The semiconductor optical amplifiers 510₁ to 510_{M} may be integrated on the FMCW Lidar chip just before the optical receivers 512₁ to 512_{M} to increase the LiDAR range and 3D pixel rate.

The photonic integrated circuit 602 enables an increase in the 3D pixel rate (points per second) of the chip-scale LiDAR by a factor of M. In this configuration, 1 to M simultaneous LiDAR transmit beams 118_{1_n} to 118_{m_n} and their corresponding receive beams 124_{1_n} to 124_{m_n} may be respectively routed to or from a selected pixel 106ₙ by controlling, using the switch matrix controller 150 illustrated in FIG. 2, the appropriate switches in both transmit and receive optical switching matrices 112₁ to 112_{M} and 114₁ to 114_{M}. Wavelength scanning for elevational beam steering may be achieved via several different source laser implementations. For example, a narrow linewidth and widely tunable (>100 nm) integrated laser source may be used.

FIG. 7 is a schematic diagram illustrating the architecture of a photonic integrated circuit 702 that is similar to the embodiment of the photonic integrated circuit 502 in FIG. 5, except that the laser system 504 having a narrow linewidth tunable laser in FIG. 5 is replaced with a laser system 704 having a narrow linewidth optical frequency comb in FIG. 7. The laser system 704 includes a narrow linewidth optical frequency comb (OFC) laser source 706 in conjunction with at least one integrated tunable microresonator 708. For an implementation with a single microresonator, the resonant wavelength of the microresonator 708 may be sequentially tuned, as shown at 710, to one of the lines of the optical comb source 706, hence mimicking a single tunable laser source illustrated in the embodiment of FIG. 5. Due to the lower optical power in each extracted comb line relative to a single tone (wavelength) laser, a semiconductor optical amplifier 716 may be provided to boost the Lidar transmit optical power. An optical modulator 718 may be coupled to the optical amplifier 716, the modulated output of which may be input to the 1×2 optical splitter 142, to generate the transmit beam 118 routed to the transmit optical switching matrix 112 and the local oscillator beam 144 routed to the optical receiver 512. The remaining portion of FIG. 7 functions similar to the photonic integrated circuit 502 of FIG. 5. Using an optical frequency comb laser instead of a single tunable laser for the chip-scale Lidar, as shown in FIG. 7, embodiments may benefit from a larger span of available wavelengths, which provides a wider range of elevational scan angles using the same dispersive optical antenna element.

FIG. 8 is a schematic diagram illustrating architecture of a photonic integrated circuit 802 that is similar to the embodiment of the photonic integrated circuit 502 in FIG. 5, except that the laser system 504 having a narrow linewidth tunable laser 506 is replaced with: a laser system 804 having a narrow linewidth optical frequency comb laser 806 with a plurality of tunable microresonators 808₁ to 808_{K} in the transmit path, and microresonators 824₁ to 824_{K} and 828₁ to 828ₖ coupled to optical receivers 512₁ to 512_{K} in the receive path. The embodiment illustrated in the photonic integrated circuit 802 is configured to extract a number of comb lines in parallel resulting in M×K 2D LiDAR positions. In the transmit path, each microresonator 808ₖ may be tuned to one of the constituent coherent optical comb lines 810ₖ of the narrow linewidth OFC laser 806, extracting a laser beam 816ₖ having an optical frequency tone (wavelength) from the comb 806 according to a wavelength selection signal 814ₖ from a microresonator controller that may be in the LiDAR sensor 100 illustrated in the embodiment of FIG. 2. The wavelength or tone selection signal 814ₖ may be provided to each micorresonator 808ₖ to generate a plurality of elevational laser beams 816₁ to 816_{K} at the same time, or in a rapid sequential or random manner. A series of waveguides is coupled to the microresonators 808₁ to 808_{K}, with each waveguide carrying a laser beam 816ₖ having a selected single optical tone (wavelength). These waveguides carry laser beams 816₁ to 816_{K} which may be coupled to an integrated photonic switch network 818, similar to the switching network 112 of the chip-scale Lidar for azimuthal scanning shown in the embodiment of FIG. 5, to emerge in a waveguide as a selected single laser beam 140ₖ which is coupled to the transmit section of the photonic integrated circuit 802 (including the transmit switch matrix 112 coupled to the switched pixel array 112), in lieu of the widely tunable source laser. The subscript k is the k^{th} wavelength associated with the k^{th} microresonator in the K microresonators 808₁ to 808_{K}.

The output of the microresonator photonic switch network 818 may be amplified. The amplified output of the semiconductor optical amplifier 820 may be directly modulated before being input to the 1×2 optical splitter 142 and sent through the transmit optical switching network 112 in the manner shown and described relative to FIG. 5, splitting the beam into a transmit beam 118ₖ and a local oscillator beam 144ₖ.

By switching through this network of waveguides 816₁ to 816_{K} according to a microresonator control signal 822, the source optical wavelength is scanned, similar to the widely tunable laser in the embodiment of FIG. 5. A plurality of wavelengths may be selected simultaneously by the switch network 818 (according to the microresonator control signal 822) in order to increase the Lidar pixel rate (3D points per second), similar to the embodiment shown in FIG. 5. In this embodiment of FIG. 8, the output waveguide carrying receive beam 124ₙ from the receive optical switching network 114 may be coupled to an integrated photonic wavelength division multiplexing (WDM) element, such as a series of tunable microring resonators 824₁ to 824_{K}, which de-multiplexes wavelengths from the plurality of simultaneous transmit beams 124_{k_n} into individual output waveguides that route receive beams 124_{1_n} to 124_{K_n}, according to a microresonator control signal 826. Each individual output waveguides carry receives beams 124_{1_n} to 124_{K_n} which is respectively paired with a corresponding local oscillator beam 144_{1_n} to 144ₖ n for downstream coherent detection of receive signals 130_{1_n} to 130_{K_n}. A series of microring resonators 826₁ to 826_{K} demultiplex the local oscillator beam 144ₖ into local oscillator beams 144_{1_n} to 144_{K_n}, according to microresonator control signal 830. The local oscillator beams 144_{1_n} to 144_{K_n} are respectively routed to corresponding optical receivers 512₁ to 512_{K}.

In the embodiment of FIG. 8, a plurality of M azimuthal beams (M being a subset of N maximum azimuthal beam positions) may be simultaneously generated using the azimuthal switch network in the transmit switch matrix 112, without the need for providing M laser systems 514₁ to 515_{M} as illustrated in FIG. 6, and a plurality of K elevational beams 118₁ to 118_{K} (K being a subset of extracted optical comb lines 816₁ to 816_{K} from a subset of microresonators 808₁ to 808_{K} may also be generated, resulting in M×K simultaneous 2D beam positions. In alternate embodiments, the tunable laser source generates one wavelength 140ₖ at-a-time. Other wavelength demultiplexing (WDM) elements (devices), such as array waveguide gratings (AWG), may also be used in place of the microresonator arrays in FIG. 8.

In yet another embodiment, an array of individual narrow linewidth lasers integrated on the Lidar chip can be used instead of the combination of the optical frequency comb laser 806 and the wavelength demultiplexing elements (such as the microresonators). This laser array (individual narrow linewidth lasers) can be coupled to the transmit switch network 818, similar to the optical frequency comb laser 806 together with microresonators 808₁ to 808_{K}.

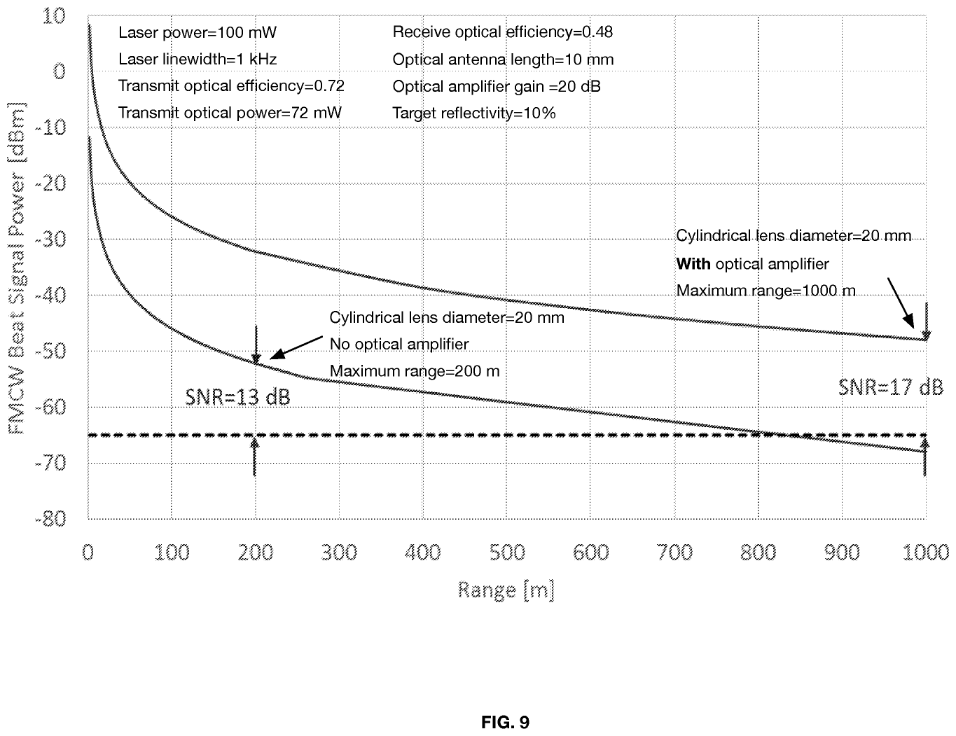

FIG. 9 shows a simulated FMCW signal-to-noise ratio (SNR) for a switched pixel array chip-scale LiDAR embodiment with interleaved transmit/receive antennas for medium (˜200 m) and long (˜1 km) target ranges. These simulations are based on a chip-scale narrow linewidth (<10 kHz) and widely tunable (>100 nm) laser integrated onto the LiDAR sensor embodiment shown in FIG. 1. This type of laser is illustrated in K. J. Boller et al., “Hybrid integrated semiconductor lasers with SiN feedback circuit,” Photonics 2020, doi: 10.3390. Also, these simulations are based on a 10-stage switch matrix with 0.1 dB optical loss per stage (1 dB total optical loss for the switch matrix), and 10 mm long optical antennas with 0.5 dB optical loss (90% efficiency). This highly efficient optical antenna was illustrated in C. Poulton et al., “Long range Lidar and free-space Datacom with high performance optical phased arrays,” IEEE J. Sel. Top. Quant. Electron., Vol. 25, No. 5, 2019. On the LiDAR receive side, the simulations are based on ˜67% (2/3 fill factor) of the receive light being focused on the two receive antennas that are interleaved with a transmit antenna, as shown in FIG. 1, resulting in an overall receive efficiency of ˜0.48 including the antenna and switch matrix optical losses. Finally, the simulations are based on a cylindrical lens used in a switched pixel array chip-scale LiDAR with interleaved transmit and receive antennas having a 20 mm diameter, resulting in an effective aperture size of 20×10 mm² (20 mm for the cylindrical lens diameter and 10 mm for the receive antennas' length onto which the receive light is focused). For the medium range LiDAR operation, no optical amplifier is used, while for the long range LiDAR operation a semiconductor optical amplifier (SOA) with a small signal gain of 20 dB is used in the simulations. The simulation results illustrate chip-scale Lidar embodiments detecting lambertian targets with only 10% reflectivity at >1 km range with signal-to-noise ratio of >15 dB. No integrated optical gain is needed in the Lidar receiver for the medium range target detection, while an integrated optical gain of ˜20 dB in the receiver may be required in order to detect km-range targets.

What is claimed is:

1. A LIDAR sensor for providing sensor data from a target, the LiDAR sensor comprising:
a switched pixel array having a plurality of pixels, each pixel in the plurality of pixels including a transmit antenna and at least two receive antennas;
a transmit optical switching network coupled to the transmit antenna in each pixel;
a receive optical switching network coupled to the at least two receive antennas in each antenna pixel;
a cylindrical lens;
a laser system that provides a transmit beam; and
an optical receiver;
wherein:
the transmit antenna and the at least two receive antennas have an antenna width and an antenna length, the antenna length being at least 100 times greater than the antenna width;
the transmit optical switching network is configured to steer the transmit beam to the transmit antenna in a selected pixel from the plurality of pixels, the transmit antenna from the selected pixel emits the transmit beam through the cylindrical lens towards the target, the transmit beam being reflected off the target as a receive beam passing through the cylindrical lens towards the at least two receive antennas in the selected pixel;
the receive optical switching network is configured to transmit the receive beam at the least two receive antennas in the selected pixel to the optical receiver system; and
the optical receiver system is configured, responsive to the receive beam, to generate a receive signal that is configured for extraction of the sensor data associated with the target.

2. The LiDAR sensor of claim 1, wherein:
the transmit antenna has a transmit aperture and at least two receive antennas have a receive aperture, the transmit aperture being interleaved in the receive aperture to provide an interleaved transmit/receive aperture for each pixel;
the transmit beam is emitted from the transmit aperture of the interleaved transmit/receive aperture for the selected pixel; and
the receive beam is detected by the receive aperture of the interleaved transmit/receive aperture for the selected pixel.

3. The LiDAR sensor of claim 1, wherein the cylindrical lens is positioned one focal length above the switched pixel array

4. The LiDAR sensor of claim 1, wherein the transmit antenna is interleaved between the at least two receive antennas for each pixel in the plurality of pixels.

5. The LiDAR sensor of claim 1, wherein the transmit antenna is spatially separated from the at least two receive antennas in a direction of the antenna length.

6. The Lidar sensor of claim 1, wherein:
the cylindrical lens has an optical axis;
the laser system includes a tunable wavelength laser;
the transmit optical switching network and the receiving switching network in conjunction with a position of the plurality of pixels relative to the optical axis of the cylindrical lens are configured for azimuthal beam steering; and
the wavelength of the tunable laser is scanned in conjunction with the plurality of pixels for elevational beam steering.

7. The Lidar sensor of claim 1, wherein the transmit optical switching network, the receive optical switching network and the laser system are configured to generate a plurality of simultaneous azimuthal and elevational beams.

8. The Lidar sensor of claim 1, wherein the laser system comprises one or more tunable lasers.

9. The Lidar sensor of claim 1, wherein the laser source comprises an optical frequency comb laser having a plurality of optical wavelengths that are each individually-selectable, and at least one wavelength demultiplexing element coupled to the optical frequency comb laser.

10. The Lidar sensor of claim 9, wherein the at least one wavelength demultiplexing element comprises a tunable microresonator.

11. The Lidar sensor of claim 9, wherein the at least one wavelength demultiplexing element is configured to select an optical wavelength from the plurality of optical wavelengths.

12. The LiDAR sensor of claim 1, further comprising a photonic integrated circuit that includes the switched pixel array, the transmit optical switching network, the receive optical switching network, the laser system, and the optical receiver.

13. The LiDAR sensor of claim 1, further comprising:
a laser driver configured to control output power and wavelength of the laser system;
a switch matrix controller configured to control selection of the transmit optical switching network and the receive optical switching network; and
a 3D image processor configured to detect and process the sensor data in the receive signal provided by the optical receiver.

14. The LiDAR sensor of claim 13, further comprising a photonic integrated circuit that is connected to the laser driver, the switch matrix controller, and the 3D image processor, wherein the photonic integrated circuit includes the switched pixel array, the transmit optical switching network, the receive optical switching network, the laser system, and the optical receiver.

15. The LiDAR sensor of claim 14, further comprising a system-on-chip that includes the photonic integrated circuit, the laser driver, the switch matrix controller and the 3D image processor.

16. A photonic integrated circuit for a LiDAR sensor that includes a cylindrical lens and provides sensor data from a target, the photonic integrated circuit comprising:
a switched pixel array having a plurality of pixels, each pixel in the plurality of pixels including a transmit antenna and at least two receive antennas;
a transmit optical switching network coupled to the transmit antenna in each pixel;
a receive optical switching network coupled to the at least two receive antennas in each antenna pixel;
a laser system that provides a transmit beam; and
an optical receiver;
wherein:
the transmit antenna and the at least two receive antennas have an antenna width and an antenna length, the antenna length being at least 100 times the antenna width;
the transmit optical switching network is configured to steer the transmit beam to the transmit antenna in a selected pixel from the plurality of pixels, the transmit antenna from the selected pixel emits the transmit beam through the cylindrical lens towards the target, the transmit beam being reflected off the target as a receive beam passing through the cylindrical lens towards the at least two receive antennas in the selected pixel;
the receive optical switching network is configured to transmit the receive beam at the least two receive antennas in the selected pixel to the optical receiver system; and
the optical receiver system is configured, responsive to the receive beam, to generate a receive signal that is configured for extraction of the sensor data associated with the target.

17. The photonic integrated circuit of claim 16, wherein:
the transmit antenna has a transmit aperture and at least two receive antennas have a receive aperture, the transmit aperture being interleaved in the receive aperture to provide an interleaved transmit/receive aperture for each pixel;
the transmit beam is emitted from the transmit aperture of the interleaved transmit/receive aperture for the selected pixel; and
the receive beam is detected by the receive aperture of the interleaved transmit/receive aperture for the selected pixel.

18. The photonic integrated circuit of claim 16, wherein the cylindrical lens is positioned one focal length above the switched pixel array

19. The photonic integrated circuit of claim 16, wherein the transmit antenna is interleaved between the at least two receive antennas for each pixel in the plurality of pixels.

20. The photonic integrated circuit of claim 16, wherein the transmit antenna is spatially separated from the at least two receive antennas in a direction of the antenna length.

21. The photonic integrated circuit of claim 16, wherein:
the cylindrical lens has an optical axis;
the laser system includes a tunable wavelength laser;
the transmit optical switching network and the receiving switching network in conjunction with a position of the plurality of pixels relative to the optical axis of the cylindrical lens are configured for azimuthal beam steering; and
the wavelength of the tunable laser is scanned in conjunction with the plurality of pixels for elevational beam steering.

22. The photonic integrated circuit of claim 16, wherein the transmit optical switching network, the receive optical switching network and the laser system are configured to generate a plurality of simultaneous azimuthal and elevational beams.

23. The photonic integrated circuit of claim 16, wherein the laser system comprises one or more tunable lasers.

24. The Lidar sensor of claim 16, wherein the laser source comprises an optical frequency comb laser having a plurality of optical wavelengths that are each individually-selectable, and at least one wavelength demultiplexing element coupled to the optical frequency comb laser.

25. The photonic integrated circuit of claim 24, wherein the at least one wavelength demultiplexing element comprises a tunable microresonator.

26. The photonic integrated circuit of claim 24, wherein the at least one wavelength demultiplexing element is configured to select an optical wavelength from the plurality of optical wavelengths.
